(19) United States
(12) Patent Application Publication
(10) Pub. No.: US 2002/0143226 A1
(43) Pub. Date: Oct. 3, 2002

(54) In-situ remediation of PAH, PCB, and DNAPL contaminants using mechanical/chemical treatment

(76) Inventors: Anuj K. Saha, Martinez, GA (US); Amitaya Sarkar, Cary, NC (US)

Correspondence Address: DORITY & MANNING, P.A., POST OFFICE BOX 1449, GREENVILLE, SC, 29602-1449, US

(21) Appl. No.: 09/766,912

(22) Filed: Jan. 22, 2001

(51) Int. Cl. A62D 3/00

(52) U.S. Cl. 588/205

(57) ABSTRACT

A treatment protocol is provided for the in-situ remediation of Polynuclear Aromatic Hydrocarbons and other contaminants such as DNAPL compounds and PCB's present both in soil and in groundwater. The approach uses a modified Fenton's chemistry to treat the materials, the treatment reagents being introduced through a hollow stem auger into the contaminated soil or groundwater region. The process also provides for a pre-treatment of solid and semi-solid coal tar residues by using a polar solvent pretreatment step prior to the chemical and mechanical treatment.

### FIELD OF THE INVENTION

This invention is directed towards an in-situ remediation process for groundwater and soil contaminated with coat tar residues such as Polynuclear Aromatic Hydrocarbons and cyanides, and polycholorinated bi-phenyls as well as volatile organic compounds such as trichloroethylene and perchloroethylene.

### BACKGROUND OF THE INVENTION

Manufactured gas plants (MGP) produce coal gases for domestic and industrial uses through a process called “High Temperature Carbonization” or coking of coal. One of the major by-products for coking of coal is the production of coal tar which contains a host of organic chemicals. During the process of coking or carbonization, these coal tar materials have often penetrated the earth's surface into the soil and in many instances to the groundwater tables and the surrounding vadose zones. Besides coal tar, several cyanide compounds are also commonly found in the soil and vadose zone.

Many of the coal tar chemicals, particularly Polynuclear Aromatic Hydrocarbons (PAH's), and the cyanides are designated as priority pollutants or listed hazardous materials. Many of the chemicals are also suspected carcinogens. As a result, a need exists to safely and effectively clean up contaminated sites.

One of the major obstacles encountered in the remediation of former MGP sites is the lack of cost-effective and high efficiency remediation technologies for treatment of the contaminants. The conventional technologies for MGP site remediation entail high costs and, except for controversial incineration, do not achieve sufficiently high destruction or treatment efficiency. Moreover the majority of the conventional technologies make use of ex-situ treatments which adds to the complexity of field deployment. A need exists for cost-effective and high efficiency treatment technology that can be deployed in an in-situ mode of treatment.

DNAPL's contaminants (e.g., trichloroethylene (TCE), tetrachloroethylene, and perchloroethylene (PCE)), were also extensively used as degreasing solvents during the 1950's through the 1970's. Like the MGP contaminates, the DNAPL contaminants have also migrated through soils and sediments and contaminated vadose zones and groundwater tables. Like remediation of MGP sites, the DNAPL contaminated sites also require cost-effective treatment technologies.

And finally, polychlorinated bi-phenyls or PCBs are well known environmental contaminants present in numerous industrial sites. Like the MGP contaminants and the DNAPLs, there is a need to deploy cost-effective in-situ remediation technologies for treatment of PCBs.

### SUMMARY OF THE INVENTION

The primary object of this invention is to offer a treatment approach which treats PAHs, DNAPLs, cyanides, other coal tar contaminants, and PCBs by in-situ chemical oxidation and mechanical augering. The in-situ chemical oxidation is achieved by deep injection of hydrogen peroxide solution and iron salt slurries while the mechanical augering is achieved by hollow stem augers fitted with injection nozzles at varying depths.

It is another object of the invention to enhance the treatment approach by adding mineral acids, such as hydrochlorous acid, to the mixes.

It is another object of this invention to provide an approach where the contaminants may be oxidized and destroyed in-situ and under ambient conditions and converted to harmless products which do not cause any regulatory or other concerns.

These and other features, aspects, and advantages of the present invention will become better understood with reference to the following description and appended claims.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings.

FIG. 1 is a schematic view of a first preferred embodiment of the invention for the in-situ treatment of coal tar wastes.

FIG. 2 is schematic view of an alternative embodiment of a treatment process setting forth a pre-treatment step for solid coal tar materials.

### DESCRIPTION OF THE PREFERRED EMBODIMENT

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features, and aspects of the present invention are disclosed in, or are obvious from, the following detailed description. It is to be understood by one of ordinary skill in the art that the present discussion is a description of exemplary embodiments only and is not intended as limiting the broader aspects of the present invention, which broader aspects are embodied in the exemplary constructions.

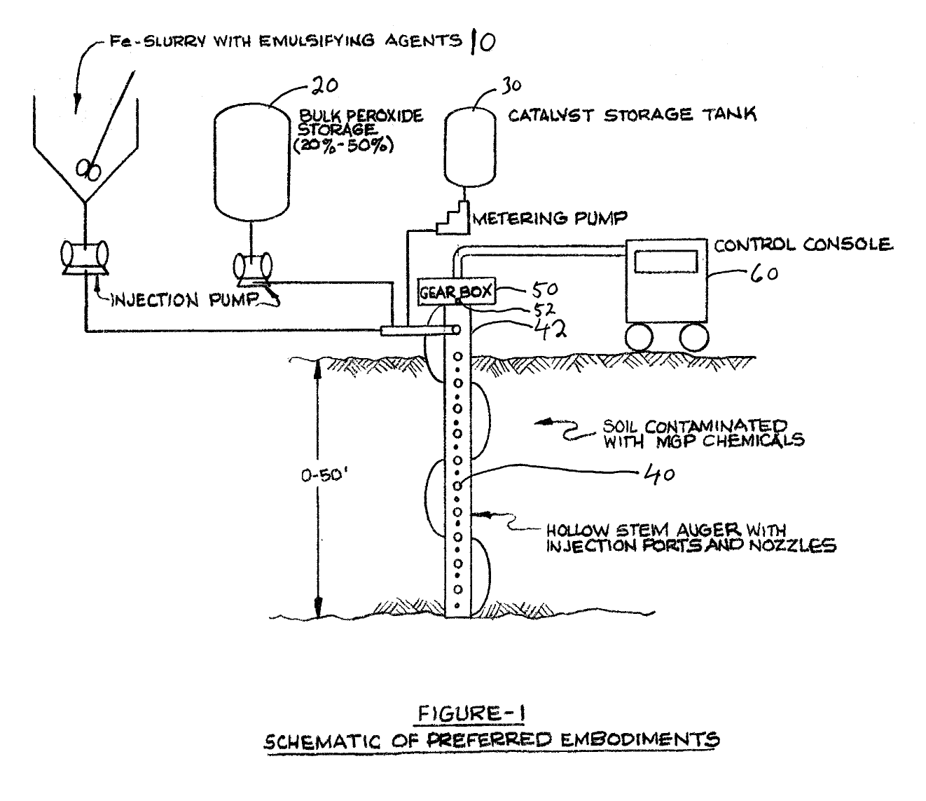

FIG. 1 shows a schematic of the preferred embodiments. Soils contaminated with MGP chemicals and/or DNAPL's or PCB's can be injected and simultaneously mixed with the treatment reactants using mechanical augers. One single hollow stem auger or dual hollow stem auger can be utilized to cause effective soil mixing.

As shown in FIG. 1, the three treatment chemicals e.g., an iron salt slurry 10 (containing the emulsifying agents), the peroxide solution 20 and the catalyst solution 30 are stored in containers and bulk storage tanks around the vicinity of the contaminated area. The powdered iron salt used for treatment is FeSO₄ and may have particle size range of 50 mesh to +300 mesh. The iron salt is mixed with hydrophilic emulsifying agents to enhance the pumping and injection characteristics.

The liquid peroxide used for oxidation treatment may be used in the concentration range of 20% to 50% H₂O₂ The peroxide solution can be stored in large storage tanks with appropriate safety features. Like peroxide, the catalyst solution is also stored in a storage tank with appropriate safety features. All the tanks are provided with conventional pumps for injection or metering of the chemicals through the injection ports. A control console 60 may be used to monitor and control the various metering pumps along with the operation of the hollow stem auger.

One catalyst suitable for carrying out this invention is a buffered solution of dehydrated FeSO₄ (ferrous sulfate) suspended in a concentrated (93% to 98%) sulfuric acid. The resulting product is an emulsion which maintains the iron in a ferrous state. The catalyst emulsion has a pH of 0.1.

All chemical injection ports 40 are imbedded into the hollow stem auger 42 which mixes the contaminated soil and the treatment reagents. Two types of conventional injection ports or nozzles are generally used. The ports that inject emulsified iron slurry have larger openings than the ones which inject liquid peroxide or catalyst solution. All ports or nozzles 40 are internally piped through the hollow auger to a manifold at the top. All interconnecting piping are flexible in nature. The hollow stem auger is connected through a gear-box 50 to a drive shaft 52 powering the soil mixing. The drive mechanism for the shaft is such that the auger rotation can be periodically reversed to cause both clockwise and counter-clock wise rotation. This reversible rotation achieves superior mixing between the treatment reagents and the MGP contaminants and/or DNAPLs or PCBs thus ensuring higher destruction. The entire soil mixing and injection operations can be controlled from the control console.

The mechanism for destruction of the MGP contaminants and DNAPLs and PCBs can be explained as follows:

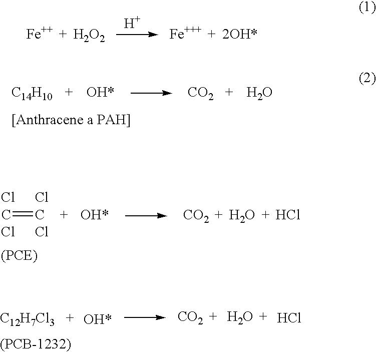

The iron salt in the presence of acid reacts with hydrogen peroxide to produce hydroxyl free radical (OH*). The hydroxyl free radical, a powerful oxidizing agent, reacts with the PAHs, DNAPLs, and PCBs present in the soil to form CO₂, H₂O, and HCI. The rate of chemical oxidation for the contaminants is enhanced by the acidic soil conditions and abundance of hydroxyl free radicals. The solubility of the contaminants, particularly if they are entrapped inside the tar or soil matrices, can also significantly affect the conversion efficiency. Accordingly, this invention provides an alternative embodiment for treatment of the contaminants embedded inside the coal or tar matrices or clay soil medium.

The amount of reagents used for treatment of contamination depends in part upon type(s) of contaminants present, relative amounts of the contaminants, and existing properties of the soil and/or groundwater. For example, in soil containing levels of PAH in excess of 5,000 ppm, it has been found useful to provide 1 pound of a 35% peroxide solution for each pound of contaminated soil. For soil containing lower levels of PAH (≦1000 ppm) 1 pound of the 35% peroxide solution may be used for every 3 to 5 pounds of contaminated soil. Similar variables influence the amount of iron salt used in conjunction with the treatment protocol. As a general rule, it has been found helpful to use equal weights of iron salt and hydrogen peroxide solution. However, the amount of iron salt needed may be decreased according to the existing iron content present within the soil or groundwater.

With respect to the quantity of catalyst solution used, it has been found that for each pound of 35% peroxide solution used in the treatment of PAH contaminants, approximately 1 ml of the concentrated catalyst FeSO₄ solution should be employed. While these amounts have been found useful in carrying out the present invention, one having ordinary skill in the art would recognize that variations of the relative amounts of the reagents may be made depending upon the properties of a treatment site. It is highly recommended that test batches of soil be analyzed under laboratory conditions to help establish the most economical mixture of reagents which are effective in the destruction of the contaminants of interest.

The use of the FeSO₄ catalyst emulsion is essential in order to carry out an adequate treatment regime. If a catalyst emulsion is not used of the emulsion is not introduced into the treatment protocol in the desired ferrous state, the reaction efficiency and resulting remediation rate is substantially reduced.

With respect to groundwater contamination by DNAPLs, it has been found that contaminant concentration ranging between 50 to 100 ppm can be effectively treated by using 1 standard drum (500 pounds) of 35% hydrogen peroxide to treat 3,000 to 5,000 gallons of contaminated groundwater. The corresponding amounts of iron salt and catalyst are used in the ranges and proportions as outlined above. For groundwater treatment, the iron salt, FeSO₄, may be premixed with the H₂SO₄ prior to injection. When premixed as described, the injection mixture functions as both the catalyst emulsion as well as the supply of the iron salt.

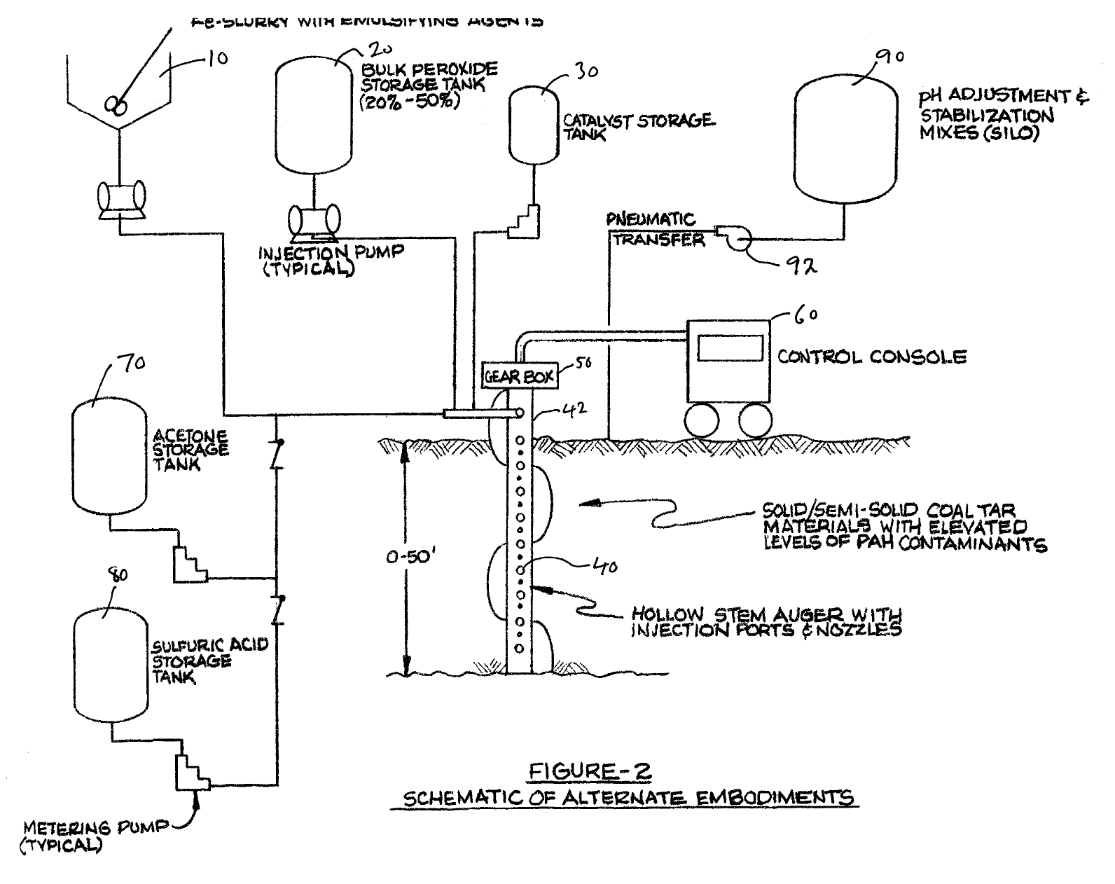

FIG. 2 shows a schematic for alternative embodiments for treatment of MGP contaminants embedded inside coal tar matrices. A survey of the defunct MGP facilities indicate that a large number of sites contain piles of coal tar containing elevated levels of MGP contaminants. Due to the nature and physical characteristics, the coal tar materials cannot be treated using augering without pretreatment. It has been found that successful treatment must entail preconditioning the solid/semi-solid coal tar materials to a fluid state suitable for chemical oxidation.

In accordance with this invention, it has been found that two (2) polar solvents may be provided which effectively solubilizes the solid/semi-solid coal tar materials and thereby brings the MGP contaminants in close contact with the oxidants and catalysts. The two solvents of choice are acetone and moderately concentrated (50%) sulfuric acid. The acetone and sulfuric acid may be stored in respective storage vessels 70 and 80 and may be dispensed as needed using conventional metering pumps. Both of the solvents have demonstrated successful dissolution of the coal tar materials to a liquid state such that the modified Fenton's chemistry can be applied to the fluid masses containing MGP contaminants.

The alternative embodiments essentially entail adding either acetone and/or moderately concentrated sulfuric acid to the coal tar materials and simultaneously mixing to dissolve the coal tar solids/residues. Following dissolution, the coal tar fluid mass containing the MGP contaminants will be injected with the modified Fenton's reagents to promote oxidation of the MGP contaminants through hydroxyl (OH*) free radical rapid oxidation. This alternative embodiment, like the preferred embodiment, can also rapidly oxidize the highly toxic cyanide (CN) constituents present within the coal tar matrices.

As further seen in reference to FIG. 2, a pH adjustment and stabilization silo 90 is provided along with a pneumatic transfer pump 92. Silo 90 and pump 92 may be used to introduce zeolite and other similar silicates so as to bind and prevent migration of heavy metals. Heavy metals present in the soil or groundwater such as arsenic, zinc, nickel, and cadmium will readily leach under highly acidic conditions such as those created by the remediation process. Accordingly, conventional stabilization methods such as the use of zeolite is desired to prevent leaching and migration of heavy metals.

Following oxidation-destruction of MGP contaminants, the coal tar residues may require pH adjustment and stabilization or solidification. This step will be particularly required if sulfuric acid is used as a solubilizing agent. The pH adjustment and stabilization can be conveniently achieved by addition and mixing of a blend of lime/limestone, Bentonite and natural Zeolites. This posttreatment step for pH adjustment and stabilization will also reduce/eliminate the mobility of heavy metal contaminants (Zn, Cr, Ni) often found in defunct MGP sites.

### EXAMPLE 1

The protocol set forth above was used to treat soils and sediments from a contaminated site. The contaminants present with the soil include the following:

| | |
|---|---|
| 1-Methylnaphthalene | Dibenzo(a,h)anthracene |
| 2-Methylnapthalene | Fluoranthene |
| Acenaphthene | Fluorene |
| Acenaphthylene | Indeno(a,2,3-cd)pyrene |
| Anthracene | Naphthalene |
| Benzo(a)anthracene | Phenanthrene |
| Benzo(a)pyrene(BAP) | Pyrene |
| Benzo(b)fluoranthene | |
| Benzo(g,h,i)perylene | |
| Benzo(k)fluoranthene | |
| Chrysene | |

As seen from the results in Table 1, the contaminant destruction efficiency is expressed as a percent value. As indicated by the data, modified Fenton reagent process is able to bring about the destruction of the indicated contaminants.

Further, the treatment protocol did not generate any VOC off-gas during the oxidation reaction. This is indicated by the results in Table 2 showing that the TCLP extraction test for the treated soil was below the regulatory levels.

### EXAMPLE 2

The alternative protocol set forth above was used to treat coal tar materials removed from a contaminated site having elevated levels of MGP contaminants. As set forth in Table 3, alternative treatment protocol using the polar solvents result in a highly effective and favorable destruction efficiency for the PAH contaminants which were assayed. The acetone dissolution process set forth in Table 3 dissolved 300 grams of tar solids in 200 mils of acetone followed by the addition of 1 pound of 35% hydrogen peroxide and 2.5 pounds of iron salt.

The use of concentrated sulfuric acid to treat the coal tar solids was carried out by taking 300 grams of tar solids and dissolving in 200 mils of a 50% solution of H₂SO₄ following by the addition of 1.5 liters of the 35% peroxide solution and 2.5 pounds of iron salt.

### EXAMPLE 3

The protocol of the first embodiment was used for the treatment of DNAPL contaminants PCE and TCE present in groundwater. The in situ groundwater treatment does not employ the use of an auger; rather, direct injection of the reagents into the groundwater plume is made using vertical wells. Following three rounds of treatment, the contaminant level was reduced by over 99% for the PCE and TCE contaminants. With respect to sample MW-11, 500 pounds of the 20% hydrogen peroxide solution was used to treat each 1,000 gallons of a groundwater plume. For each 1,000 gallons of groundwater plume, 0.5 liters of a 93% H₂SO₄ and 500 grams of FeSO₄ were also used.

For treatment MW-17, 350 pounds of 20% hydrogen peroxide solution was used for each 1,000 gallons of the groundwater plume. In addition, for each 1,000 gallons of groundwater plume, 333 mils of a 93% H₂SO₄ solution and 350 grams of FeSO₄ were also used.

For sample MW-18, 250 pounds of a 20% hydrogen peroxide solution was used for each 1,000 gallons of the groundwater plume. Further, 250 mls of a 93% H₂SO₄ solution and 250 grams of FeSO₄ were used in the reagent treatment protocol. Additional data for the groundwater treatment is set forth in Table 4.

### EXAMPLE 4

The protocol for first embodiment was used for the treatment of PCB contaminants in soil medium. As indicated by the test data in Table 5, modified Fenton chemistry is able to bring about the destruction of PCB isomers. With respect to test samples 1, 2, and 3, 250 grams of PCB contaminated soil was injected with a treatment solution comprising 250 mls of a 20% hydrogen peroxide solution along with 20 mls of 93% H₂SO₄ solution and 100 grams of FeSO₄. For samples 4-6, 250 grams of the PCB contaminated soil was injected with 200 mls of a 20% hydrogen peroxide solution, 15 mls of a 93% H₂SO₄ solution, and 75 grams of FeSO₄.

TABLE 1
PAH Destruction Efficiency Using Chemical-Mechanical Treatment

| | Total PAH | BAP* | Naphthalene | Cyanide |
|---|---|---|---|---|
| | Destruction | Destruction | Destruction | Destruction |
| | Efficiency | Efficiency | Efficiency | Efficiency |
| Test | (%) | (%) | (%) | (%) |
| 1 | 77.67 | 83.93 | 82.19 | Not Analyzed |
| 2 | 80.62 | 84.84 | 79.45 | Not Analyzed |
| 3 | 84.34 | 90.00 | 89.04 | 97.77 |
| 4 | 97.45 | 93.93 | 95.89 | 97.40 |
| 5 | 89.14 | 87.87 | 93.15 | Not Analyzed |
| 6 | 94.10 | 88.39 | 98.12 | Not Analyzed |
| 7 | 97.71 | 94.10 | 98.75 | Not Analyzed |
| 8 | 98.98 | 94.64 | 98.75 | 97.85 |
| 9 | 99.08 | 97.32 | 98.75 | 97.67 |
| 10 | 97.49 | 94.10 | 98.12 | Not Analyzed |

Confirmatory
Tests

| | | | | |
|---|---|---|---|---|
| 4 (Repeat) | 94.31 | 93.93 | 95.47 | 98.81 |
| 9 (Repeat) | 97.59 | 95.35 | 98.25 | 97.85 |

*BAP = Benzo-alpha-pyrene

TABLE 2
Results of VOC Off-Gas and Treated Soil TCLP Analysis

| | | |
|---|---|---|
| | | Result Units: mg/L |
| Analyte Name | Analytical Results | Reported Detection Limits |

ANALYSIS: TCLP Metals (Treated Soil)

| | | |
|---|---|---|
| Arsenic (Reg. Limit = 5.0) | 1.7 | 1.0 |
| Barium (Reg. Limit = 100.0) | <RDL | 1.0 |
| Cadmium (Reg. Limit = 1.0) | <RDL | 1.0 |
| Chromium (Reg. Limit = 5.0) | <RDL | 1.0 |
| Lead (Reg. Limit = 5.0) | <RDL | 1.0 |
| Selenium (Reg. Limit = 1.0) | <RDL | 1.0 |
| Silver (Reg. Limit = 5.0) | <RDL | 1.0 |
| | | Result Units: mg/L |
| | | Reported |
| Analyte Name | Analytical Results | Detection Limit |

ANALYSIS: TCLP SVOC's (Treated Soil)

| | | |
|---|---|---|
| 1,4-Dichlorobenzene (Reg. Limit = 7.5) | <RDL | 0.04 |
| 2,4,5-Trichlorophenol (Reg. Limit = 400.0) | <RDL | 0.04 |
| 2,4,6-Trichlorophenol (Reg. Limit = 2.0) | <RDL | 0.04 |
| 2,4-Dinitrotoluene (Reg. Limit = 0.13) | <RDL | 0.04 |
| 2-Methylphenol (Reg. Limit = 200.0) | <RDL | 0.04 |
| 4-Methylphenol (Reg. Limit = 200.0) | <RDL | 0.04 |
| Hexachlorobenzene (Reg. Limit = 0.13) | <RDL | 0.04 |
| Hexachlorobutadiene (Reg. Limit = 0.5) | <RDL | 0.04 |
| Hexachloroethane (Reg. Limit = 3.0) | <RDL | 0.04 |
| Nitrobenzene (Reg. Limit = 2.0) | <RDL | 0.04 |
| Pentachlorophenol (Reg. Limit = 100.0) | <RDL | 0.04 |
| Pyridine (Reg. Limit = 5.0) | <RDL | 0.04 |
| Total Cresol (Reg. Limit = 200.0) | <RDL | 0.04 |
| | | Results Units mg/m³ |
| | | Reported |
| Analyte Name | Analytical Results | Detection Limit |

ANALYSIS: OFF-GAS VOC

| | | |
|---|---|---|
| 1,1-Dichloroethene | <RDL | 0.05 |
| 1,2-Dichloroethane | <RDL | 0.05 |
| Benzene | <RDL | 0.05 |
| Carbon Tetrachloride | <RDL | 0.05 |
| Chlorobenzene | <RDL | 0.05 |
| Chloroform | <RDL | 0.05 |
| Methyl ethyl ketone | <RDL | 0.05 |
| Terrachloroethene | <RDL | 0.05 |
| Trichloroethene | <RDL | 0.05 |
| Vinyl chloride | <RDL | 0.05 |

TABLE 3
Results of Alternative Treatment for Coal Tar Solids
Via Solvent Dissolution

| | | Total PAH | | |
|---|---|---|---|---|
| | Total PAH | (Following | | |
| | (Following | Dissolution in | | |
| | dissolution in | 50% H₂SO₄ and | | |
| Total PAH | Acetone- | Chemical | | |
| (Initial) | Chemical | Oxidation) | PAH Destruction Efficiency | |
| mg/kg | Oxidation) mg/kg | mg/kg | Via Acetone | Via 50% H₂SO₄ |
| 34,280 | 6.30 | 1.98 | 99.98% | 99.99% |

TABLE 4
Results of DNAPL Treatment In Groundwater
PCE/TCE Concentrations (μg/L)

| Location | Initial | 1^{st} Round | 2^{nd} Round | 3^{rd} Round |
|---|---|---|---|---|
| MW-11 | 6020/11540 | 590/980 | 120/190 | 38/65 |
| MW-17 | 3560/7320 | 405/650 | 95/125 | 33/42 |
| MW-18 | 2120/4860 | 200/430 | 45/82 | 18/29 |

TABLE 5
Results of PCB Destruction in Soil Medium

| | | PCB-1232 Concentration | |
|---|---|---|---|
| | Initial PCB-1232 Isomer | After Chemical Oxidation | Destruction |
| Test # | Concentration (mg/kg) | (mg/kg) | Efficiency (%) |
| 1 | 130 | 0.65 | 99.50 |
| 2 | 140 | 1.10 | 99.21 |
| 3 | 130 | 1.20 | 99.07 |
| 4 | 150 | 1.50 | 99.00 |
| 5 | 93 | 0.95 | 98.97 |
| 6 | 99 | 1.60 | 98.38 |

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged, both in whole or in part. Therefore, the spirit and scope of the appended claims should not be limited to the description of the preferred versions contained therein.

That which is claimed is:

1. A process of treating coal tar waste comprising:
providing a source of a peroxide liquid having a peroxide concentration of between 20% and 50%;
providing a supply of catalyst;
providing an iron salt slurry having an effective amount of emulsifying agents suitable for injecting the slurry through nozzles;
introducing the iron salt slurry, peroxide, and catalyst solutions to a hollow stem auger, the hollow stem auger defining a plurality of injection ports along a length of the auger;
rotating the auger within a supply of soil contaminated with PAH, while injecting the iron salt slurry, peroxide, and catalyst;
continuing the agitation of the soil by the hollow stem auger; and
repeating the above steps until the concentration of PAH within the soil is reduced to a desired level.

2. The treatment process according to claim 1 comprising the additional steps of:
supplying to the hollow stem auger a solubilizing mixture selected from the group consisting of acetone, sulfuric acid, and combinations thereof to the auger;
mixing a solid or semi-solid coal tar material within the soil using the auger and the solubilizing mixture; and,
solubilizing the solid and semi-solid coal tar materials to a state where additional treatment additives may be introduced.

3. A process of solubilizing solid and semi-solid coal tar materials for subsequent remediation comprising the steps of:
supplying a solubilizing agent to a hollow stem auger having a plurality of injection ports;
rotating the auger while releasing the solubilizing agent;
mixing the solid and semi-solid coal tar materials with the acetone and sulfuric acid, thereby providing a solubilized coal tar material suitable for chemical remediation.

4. A process of treating hazardous waste comprising:
providing a source of a peroxide liquid having a peroxide concentration of between 20% and 50%;
providing a supply of catalyst;
providing an iron salt slurry having an effective amount of emulsifying agents suitable for injecting the slurry through nozzles;
introducing the iron salt slurry, peroxide, and catalyst solutions to a hollow stem auger, the hollow stem auger defining a plurality of injection ports along a length of the auger;
rotating the auger within a supply of soil contaminated with a hazarous waste selected from the group consisting of PAH, PCB, DNAPL, cyanide compounds, and combinations thereof, while injecting the iron salt slurry, peroxide, and catalyst;
continuing the agitation of the soil by the hollow stem auger; and
repeating the above steps until the concentration of contaminants within the soil is reduced to a desired level.

5. The process of treating groundwater contamination comprising:
providing a supply of liquid peroxide having a concentration of between about 20% to about 50%;
providing a liquid emulsion of FeSO₄ suspended in sulfuric acid;
introducing the emulsion and the liquid peroxide into a groundwater contaminated plume, the plume having contaminants selected from the group consisting of PAH, PCB, DNAPL, cyanide compounds, and combinations thereof; and,
repeating the above steps until the concentration of contaminants within the groundwater plume is reduced to a desired level.
